(19) United States
(12) Patent Application Publication
(10) Pub. No.: US 2013/0128192 A1
(43) Pub. Date: May 23, 2013

(54) LIQUID CRYSTAL DISPLAY DEVICE AND MANUFACTURING METHOD FOR SAME

(71) Applicants: Kazuhide Ishikawa, Osaka (JP); Tomoyuki Nagai, Osaka (JP); Shohichi Andoh, Osaka (JP); Noriyuki Ohashi, Osaka (JP)

(72) Inventors: Kazuhide Ishikawa, Osaka (JP); Tomoyuki Nagai, Osaka (JP); Shohichi Andoh, Osaka (JP); Noriyuki Ohashi, Osaka (JP)

(73) Assignee: SHARP KABUSHIKI KAISHA, Osaka (JP)

(21) Appl. No.: 13/813,467

(22) PCT Filed: Jul. 26, 2011
(86) PCT No.: PCT/JP2011/004208

§ 371 Date: Jan. 31, 2013

(30) Foreign Application Priority Data
Aug. 2, 2010 (JP) 2010-173573

(51) Int. Cl. G02F 1/1335; G02F 1/13

(52) U.S. Cl. CPC G02F 1/133512; G02F 1/1303
USPC 349/96; 445/25

(57) ABSTRACT

A liquid crystal display device (10) is provided with: a first substrate (20) and a second substrate (30) disposed so as to face one another; a sealing member (40) disposed in a seal region (SL) that is formed continuously in a ring shape along a frame region (F) surrounding a display region (D), the sealing member being provided to bond the first substrate (20) and the second substrate (30) to each other; a liquid crystal layer (50) that is provided between the two substrates (20, 30) and that is enclosed by the sealing member (40); a first polarizing plate (61) provided on the first substrate (20) on a side opposite to the liquid crystal layer (50); and a second polarizing plate (62) provided on the second substrate (30) on a side opposite to the liquid crystal layer (50). In a region within the frame region (F) that at least includes part of the seal region (SL), a frame light-shielding layer (25) is provided at least between the first substrate (20) and the first polarizing plate (61), and the frame light-shielding layer (25) defines a frame light-shielding region (SD).

### TECHNICAL FIELD

The present invention relates to a display device and to a manufacturing method thereof. More particularly, the present invention relates to a liquid crystal display device that can achieve a narrower frame without decreasing a seal strength, and to a manufacturing method thereof.

### BACKGROUND ART

Liquid crystal display devices are widely used as displays for televisions, OA devices such as personal computers, and portable information devices such as mobile phones and PDAs (Personal Digital Assistant) due to advantages of thinner profile and lower power consumption.

A liquid crystal display device includes a display panel and a backlight unit disposed on the rear surface of the display panel. The display panel is made of two substrates (array substrate and color filter substrate) disposed to face each other, and these two substrates are bonded by a sealing member that is disposed in a frame shape along the outer circumference thereof. A display region where an image is displayed is provided inside the frame-shaped sealing member.

In order to suppress light leakage from a frame region that surrounds the display region, the display panel has a light-shielding region in the frame region. Generally, this frame light-shielding region is formed using the same material as that of a black matrix, which borders each pixel, in the same manufacturing step (Patent Document 1, for example).

In recent years, with increasing demands for display devices such as liquid crystal display devices that are smaller in size and that have a larger display region, research and development for making the frame region around the display region narrower have been underway. The narrower frame region can be achieved by techniques such as reducing the width of the sealing member or reducing a region between the seal region and the display region, for example.

### RELATED ART DOCUMENT

Patent Document

Patent Document 1: Japanese Patent Application Laid-Open Publication No. H09-005756

### SUMMARY OF THE INVENTION

Problems to be Solved by the Invention

To address the increasing demand for the narrower frame, it became necessary to dispose the seal region and the frame light-shielding region so as to overlap each other, thereby reducing an area between the seal region and the display region. However, when the sealing member is disposed to overlap a light-shielding layer, which was formed in the frame region as a frame light-shielding region, the adhesion strength of the sealing member is decreased. Although a sufficient seal strength can be ensured by increasing the width of the sealing member, in order to achieve a narrower frame, the sealing member can only be widened to a certain extent. Therefore, other techniques than increasing the width of the sealing member are needed to ensure a sufficient seal strength.

An object of the present invention is to achieve a narrower frame in a display device without decreasing the seal strength of a sealing member provided in a display panel.

Means for Solving the Problems

A liquid crystal display device of the present invention includes:

a first substrate and a second substrate disposed to face each other;

a sealing member disposed in a seal region that is a region continuously formed in a ring shape along a frame region that surrounds a display region, the sealing member bonding the first substrate and the second substrate to each other;

a liquid crystal layer provided in a region enclosed by the sealing member between the first substrate and the second substrate;

a first polarizing plate disposed on the first substrate on a side opposite to a liquid crystal layer;

a second polarizing plate disposed on the second substrate on a side opposite to a liquid crystal layer; and

a frame light-shielding layer disposed, at least between the first substrate and the first polarizing plate, in a region within the frame region that includes at least a part of the seal region, the frame light-shielding layer defining a frame light-shielding region.

With the configuration above, in a region within the frame region, which includes at least a part of the seal region, a frame light-shielding layer is disposed at least between the first substrate and the first polarizing plate, and the frame light-shielding layer defines a frame light-shielding region. Therefore, even when the seal region and the frame light-shielding region overlap each other, the sealing member can be disposed so as to be directly adhered to the first substrate. This makes it possible to achieve a layout of a frame region in which the seal region and the frame light-shielding region overlap each other, without decreasing the seal strength, and as a result, the narrower frame in the display panel can be realized.

When the frame light-shielding layer is disposed on the surface of the substrate on a side facing the liquid crystal layer as in a conventional liquid crystal display device, two substrates are bonded by the sealing member after forming the frame light-shielding layer. Therefore, if using a sealing member made of a photosetting resin, it is necessary to design a layout such that the seal region can receive light for curing the sealing member. However, in the above-mentioned configuration, because the frame light-shielding layer is disposed between the first substrate and the first polarizing plate, the frame light-shielding layer can be formed after the first substrate and the second substrate are bonded to each other, that is, after the sealing member is cured. This makes it possible to form the frame light-shielding region without taking into account a step of curing the sealing member. As a result, it is possible not only to achieve the narrower frame by disposing the frame light-shielding region and the seal region so as to overlap each other, but also to use the entire frame region as the frame light-shielding region. Therefore, excellent light-shielding performance and excellent brightness characteristics are obtained.

In the liquid crystal display device of the present invention, it is preferable that the first substrate be a color filter substrate that has colored layers provided for respective pixels, and the second substrate be an array substrate that has switching elements formed so as to correspond to the respective pixels.

In the liquid crystal display device of the present invention, it is preferable that, between the color filter substrate and the first polarizing plate, an inter-pixel light-shielding layer be formed of the same layer as the frame light-shielding layer so as to correspond to a region that borders the respective colored layers.

With this configuration, because the frame light-shielding layer and the inter-pixel light-shielding layer are formed in the same layer between the color filter substrate and the first polarizing plate, it is possible to form the frame light-shielding layer and the inter-pixel light-shielding layer at the same time.

In the liquid crystal display device of the present invention, the sealing member may be black.

With this configuration, because the sealing member is black and allows little light to pass through, it is possible to obtain excellent light-shielding performance in the seal region.

The liquid crystal display device of the present invention can be suitably used for a case in which the display region is in a polygonal shape.

The liquid crystal display device of the present invention can be suitably used for a case in which the display region is in a circular shape.

A method of manufacturing a liquid crystal display device of the present invention includes:

a mother substrate bonding step of bonding a first mother substrate from which a plurality of color filter substrates are formed and a second mother substrate from which a plurality of array substrates are formed, thereby obtaining a mother substrate assembly;

a first light-shielding material application step of forming, by an ink-jet method, a light-shielding film on a surface of the mother substrate assembly, which was obtained in the mother substrate bonding step, on a side of the first mother substrate in a region that corresponds to a frame region;

a cutting step of cutting the mother substrate assembly into individual panels, each of which has one color filter substrate and one array substrate facing each other, after forming the light-shielding film in the first light-shielding material application step;

a second light-shielding material application step of applying a light-shielding material by an ink-jet method onto a surface of a panel, which was obtained in the cutting step, in a region that corresponds to a location where the light-shielding film is formed, thereby forming a frame light-shielding layer;

a liquid crystal layer forming step of filling a space between the color filter substrate and the array substrate with a liquid crystal material, the liquid crystal layer forming step being performed before the mother substrate bonding step, or after one of the mother substrate bonding step, the first light-shielding material application step, the cutting step, and the second light-shielding material application step;

a first polarizing plate bonding step of bonding a first polarizing plate to a surface of the panel on a side of the color filter substrate after the second light-shielding material application step; and

a second polarizing plate bonding step of bonding a second polarizing plate to a surface of the panel on a side of the array substrate, subsequent to one of the cutting step, the second light-shielding material application step, and the first polarizing plate bonding step.

With this manufacturing method, a light-shielding film is formed as a base of the frame light-shielding layer in the first light-shielding material application step after the mother substrate bonding step, and thereafter, in the cutting step, the mother substrate assembly is cut into individual panels, each of which has one color filter substrate and one array substrate facing each other. This makes it possible to form a light-shielding film for a plurality of panels at once, which increases efficiency. Also, if the mother substrate assembly is cut after the light-shielding film is formed on the mother substrate assembly, it is possible that the light-shielding film has very small damage due to damage in the end face of a panel. However, because the portion with very small damage in the light-shielding film can be repaired by being coated with a light-shielding material provided in the second light-shielding material application step that follows the cutting step. As a result, the frame light-shielding layer can reliably shield light in the frame light-shielding region.

### EFFECTS OF THE INVENTION

According to the present invention, a frame light-shielding layer is disposed in a region within the frame region that includes at least a part of the seal region at least between the first substrate and the first polarizing plate, and the frame light-shielding region is defined by the frame light-shielding layer. Therefore, it is possible to dispose a sealing member so as to be directly adhered to the first substrate even when the seal region and the frame light-shielding region overlap each other. This makes it possible to achieve a layout of the frame region in which the seal region and the frame light-shielding region overlap, without decreasing the seal strength. As a result, a narrower frame in the display panel can be achieved.

### BRIEF DESCRIPTION OF THE DRAWINGS

FIG. 1 is a schematic plan view of a liquid crystal display device of Embodiment 1.

FIG. 2 is a schematic cross-sectional view along the line II-II in FIG. 1.

FIG. 3 is a plan view of a liquid crystal display device, showing an enlarged view of the region III in FIG. 1.

FIG. 4 is a cross-sectional view along the line IV-IV in FIG. 3.

FIG. 5 is a cross-sectional view along the line V-V in FIG. 3.

FIG. 6 is a cross-sectional view of a liquid crystal display device of Modification Example 1, corresponding to a cross-sectional view along the line IV-IV in FIG. 3.

FIG. 7 is a cross-sectional view of a liquid crystal display device of Modification Example 2, corresponding to a cross-sectional view along the line IV-IV in FIG. 3.

FIG. 8 is a cross-sectional view of a liquid crystal display device of Modification Example 3, corresponding to a cross-sectional view along the line IV-IV in FIG. 3.

FIG. 9 is a cross-sectional view of a liquid crystal display device of Embodiment 2, corresponding to a cross-sectional view along the line IV-IV in FIG. 3.

FIG. 10 is a cross-sectional view of a liquid crystal display device of Modification Example 4, corresponding to a cross-sectional view along the line IV-IV in FIG. 3.

FIG. 11 is a cross-sectional view of a liquid crystal display device of Modification Example 5, corresponding to a cross-sectional view along the line IV-IV in FIG. 3.

FIG. 12 is a cross-sectional view of a liquid crystal display device of Modification Example 6, corresponding to a cross-sectional view along the line IV-IV in FIG. 3.

FIG. 13 is a cross-sectional view of a liquid crystal display device of Modification Example 7, corresponding to a cross-sectional view along the line IV-IV in FIG. 3.

FIG. 14 is a cross-sectional view of a liquid crystal display device of Modification Example 8, corresponding to a cross-sectional view along the line IV-IV in FIG. 3.

FIG. 15 is a plan view of a liquid crystal display device of Modification Example 9.

FIG. 16 is a cross-sectional view along the line XVI-XVI in FIG. 15.

FIG. 17 is a plan view of a liquid crystal display device of Modification Example 10.

FIG. 18 is a plan view of a liquid crystal display device of Modification Example 11.

FIG. 19 is a plan view of a liquid crystal display device, showing an enlarged view of the region XIX in FIG. 18.

FIG. 20 is a cross-sectional view of a liquid crystal display device of Modification Example 12, corresponding to a cross-sectional view along the line IV-IV in FIG. 3.

### DETAILED DESCRIPTION OF EMBODIMENTS

Below, embodiments of the present invention will be explained in detail with reference to figures. In the embodiments below, as an example of a display device, an active matrix type liquid crystal display device 10 having a thin film transistor (TFT) in each pixel will be explained. However, the present invention is not limited to the embodiments below, and may have other configurations. In the respective embodiments below, the same reference characters are given to configurations that correspond to each other.

### Embodiment 1

<Configuration of Liquid Crystal Display Device>

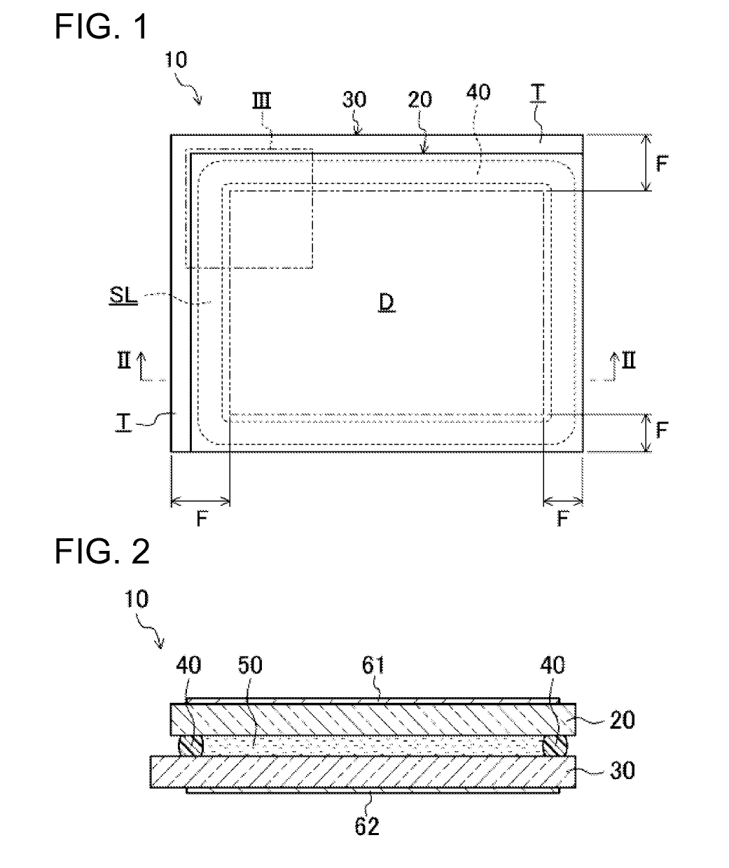

FIGS. 1 to 5 show the liquid crystal display device 10 of this embodiment. The liquid crystal display device 10 includes a color filter substrate 20 (first substrate) and an array substrate 30 (second substrate) disposed so as to face each other. The two substrates 20 and 30 are bonded to each other by a sealing member 40 that is formed in a frame shape in a seal region SL on the outer circumference thereof. In a space surrounded by the sealing member 40 between the two substrates 20 and 30, a liquid crystal layer 50 is provided as a display layer.

The liquid crystal display device 10 has a rectangular display region D inside the sealing member 40, where a plurality of pixels are arranged in a matrix, and a region that surrounds the display region is a frame region F.

(Color Filter Substrate)

As shown in FIG. 4, in the color filter substrate 20, respective colored layers of red colored layers 22R, green colored layers 22G, and blue colored layers 22B are formed on the surface of the substrate 21 on the side of the liquid crystal layer 50 so as to correspond to respective pixels in the display region D. On the respective colored layers 22R, 22G, and 22B, a common electrode 23 is formed of ITO or the like in a thickness of about 100 nm, for example, and an alignment film (not shown) is formed so as to cover the common electrode 23.

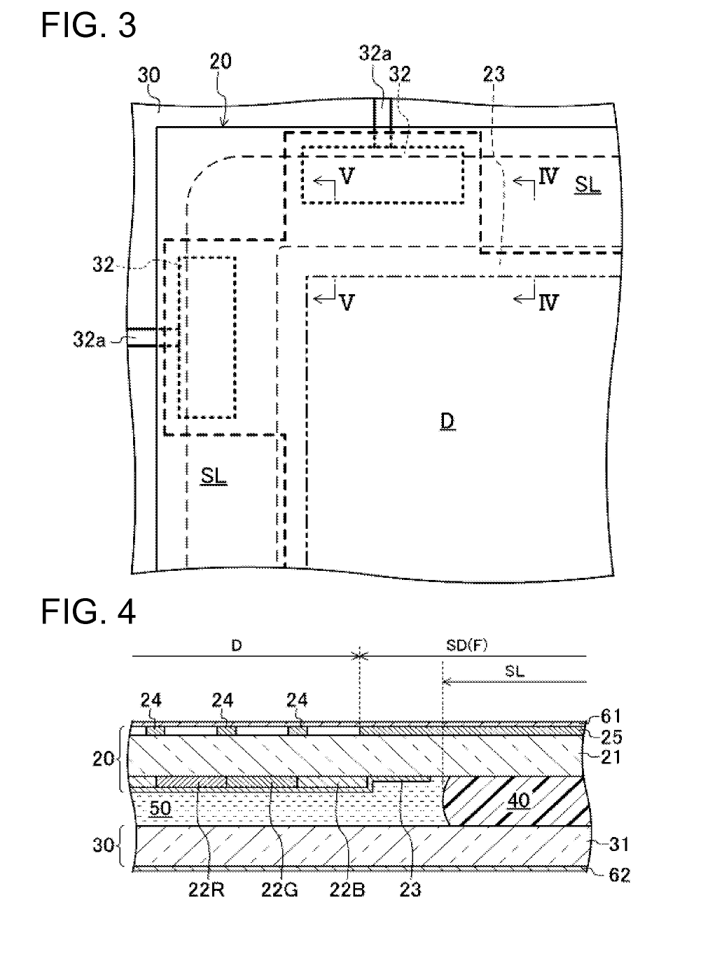

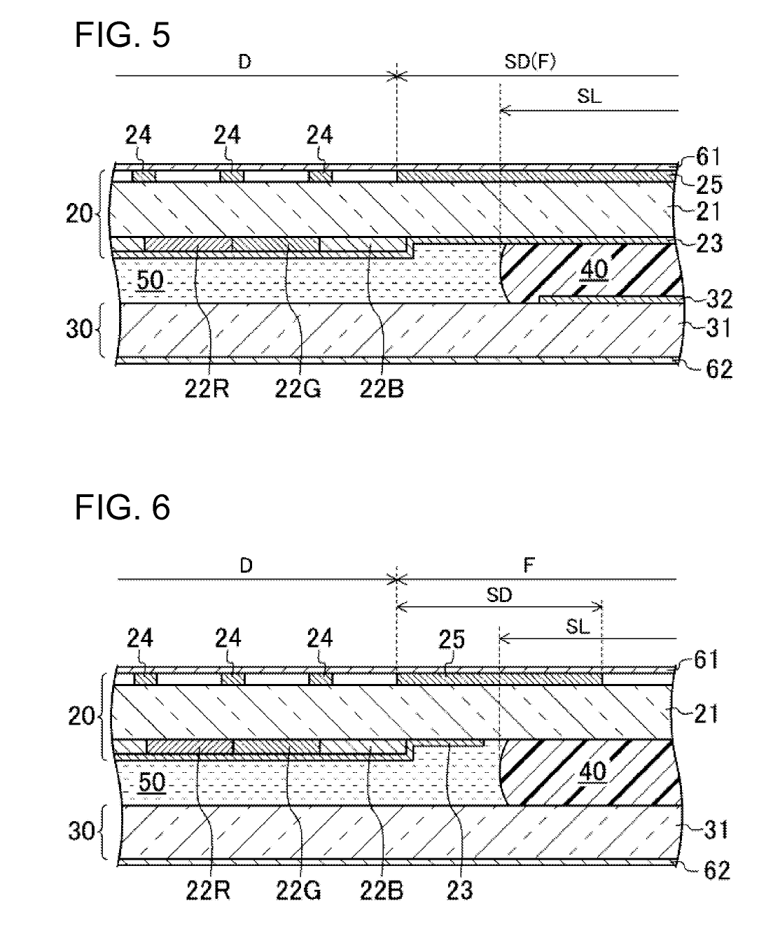

As shown in a plan view of FIG. 3, in the display region D, the common electrode 23 is formed so as to cover the entire display region D. On the other hand, in the frame region F, the common electrode 23 is formed so as to correspond to regions where transfer pads 32, which will be described below, are formed. The layout of the common electrode 23 in the frame region F will be later described with reference to FIGS. 4 and 5.

The color filter substrate 20 also includes, on the surface of the substrate 21 on the side opposite to the liquid crystal layer 50, an inter-pixel light-shielding layer 24 formed so as to border the respective pixels in the display region D, and a frame light-shielding layer 25 formed so as to cover the entire frame region F. The frame light-shielding layer 25 defines a frame light-shielding region SD. That is, the frame light-shielding region SD is formed so as to cover the entire frame region F. The respective inter-pixel light-shielding layer 24 and frame light-shielding layer 25 are formed of a black resin, metal chrome, or the like, for example. The inter-pixel light-shielding layer 24 and the frame light-shielding layer 25 are formed of the same material in the same layer.

(Array Substrate)

Although not shown in the figures, the array substrate 30 has a configuration that is conventionally known, and includes, on a substrate 31, a plurality of gate lines that extend in parallel with each other and a plurality of source lines that extend in parallel with each other so as to intersect with the gate lines through an insulating film, for example. Semiconductor layers are disposed near respective intersections of the gate lines and the source lines, and thin film transistors are disposed so as to correspond to the respective pixels. A passivation film and an interlayer insulating film are formed so as to cover them, and in each pixel, a pixel electrode that is electrically connected to a TFT is provided. On the pixel electrodes, an alignment film is formed so as to cover the display region D.

A part of the frame region F of the array substrate 30 is extended beyond the color filter substrate 20, thereby forming a terminal region T where external connection terminals (not shown) for mounting components and the like are provided. As shown in FIG. 3, in the frame region F, transfer pads 32 are formed to provide a common potential to the common electrode 23 of the color filter substrate 20. The respective transfer pads 32 are connected to transfer bus lines (not shown) that are arranged in the terminal region T through lead-out lines 32a.

As shown in FIG. 4, in a region where the transfer pads 32 are not formed, the common electrode 23 is arranged so as not to overlap the seal region SL. Because the common electrode 23 is not formed in the seal region SL, the sealing member 40 can be directly adhered to the substrate 21 in the seal region SL, thereby ensuring the seal strength of the sealing member 40.

On the other hand, as shown in FIG. 5, in the region where the transfer pads 32 are formed, the common electrode 23 is formed so as to overlap the seal region SL. This way, the common electrode 23 and the transfer pads 32 face each other through the sealing member 40. As described below, the sealing member 40 includes conductive beads (not shown) mixed therein, and therefore, the common electrode 23 and the transfer pads 32 are electrically connected through the conductive beads. This allows the transfer pads 32 to apply a common potential to the common electrode 23.

(Sealing Member)

In the frame region F on the outer circumference of the color filter substrate 20 and the array substrate 30, the seal region SL is defined in a ring shape, and the sealing member 40 is disposed so as to extend along the seal region SL. The sealing member 40 bonds the color filter substrate 20 and the array substrate 30 to each other.

The sealing member 40 is made of a sealing material that is mainly made of an adhesive that has fluidity such as a thermal-setting resin or a UV curable resin (acrylic resin or epoxy resin, for example), and is formed by curing such a material by heat application or UV light radiation. The sealing member 40 has conductive beads mixed therein, for example, and functions as a medium for electrically connecting the common electrode 23 to the transfer pads 32. The sealing member 40 has a width of about 0.4 to 0.8 mm, for example.

The seal region SL is formed so as to overlap the frame light-shielding region SD in a plan view. Because the seal region SL and the frame light-shielding region SD are disposed so as to overlap each other, the frame region can be made narrower. A space between the display region D and the seal region SL is set to about 0.2 to 0.5 mm, for example.

(Liquid Crystal Layer)

The liquid crystal layer 50 is made of a nematic liquid crystal material or the like that has electrooptic characteristics.

(Polarizing Plate)

The first and second polarizing plates 61 and 62 are respectively provided on a surface of the color filter substrate 20 and a surface of the array substrate 30. Each of the first and second polarizing plates 61 and 62 has a known configuration.

In the liquid crystal display device 10 having the above configuration, one pixel is defined for each pixel electrode, and in each pixel, when the TFT is turned on as a result of a gate signal sent through the gate line, a source signal is received through the source line, causing prescribed electrical charges to be written into the pixel electrode through the source electrode and the drain electrode. This creates a difference in potential between the pixel electrode and the common electrode 23 of the color filter substrate 20, and as a result, a prescribed voltage is applied to a liquid crystal capacitance made of the liquid crystal layer 50. The orientation state of the liquid crystal molecules changes depending on the size of the voltage applied thereto, and by utilizing the change in the orientation state to adjust the transmittance of light that enters from the outside, the liquid crystal display device 10 displays an image.

<Manufacturing Method of Liquid Crystal Display Device>

Below, a method of manufacturing the liquid crystal display device 10 of this embodiment will be explained. Here, two methods of manufacturing the liquid crystal display device 10 are explained as the first manufacturing method and the second manufacturing method.

(First Manufacturing Method of Liquid Crystal Display Device)

The first manufacturing method of the liquid crystal display device 10 includes a mother substrate fabricating process, a liquid crystal layer forming process, a mother substrate bonding process, a light-shielding material application process, a cutting process, and a first and second polarizing plates bonding process.

Mother Substrate Fabricating Process

First, a first mother substrate for forming a plurality of color filter substrates 20 is fabricated. For example, at first, colored layers 22R, 22G, and 22B are formed on the first mother substrate by a known method, and after forming a common electrode 23 thereon, an alignment film is formed. Separately from the first mother substrate, a second mother substrate for forming a plurality of array substrates 30 is fabricated by a known method.

Liquid Crystal Layer Forming Process

Next, by a known method, a sealing material is applied on the first mother substrate so as to enclose each region that becomes a display region D in a frame shape (that is, in each region that becomes a frame region F). Thereafter, by a dispenser method or the like, for example, a liquid crystal material is dropped onto the first mother substrate in each region enclosed by the sealing material, thereby forming a liquid crystal layer 50.

Mother Substrate Bonding Process

Thereafter, the first mother substrate and the second mother substrate are arranged such that the respective display regions D face each other, and by bonding the two substrates, a mother substrate assembly is obtained. Next, by radiating UV light and/or applying heat to regions where the sealing material is disposed in the mother substrate assembly, the sealing material is cured, thereby forming a sealing member 40. The region where the sealing member 40 is provided is a seal region SL.

Light-Shielding Material Application Process

A light-shielding material is applied by an ink-jet method to a surface of the first mother substrate to form a light shielding film in regions where the frame regions are to be formed (regions where frame light-shielding layers 25 are to be formed) and where inter-pixel light-shielding layers 24 are to be formed, thereby forming frame light-shielding layers 25 and inter-pixel light-shielding layers 24. Because curing of the sealing material was performed in the mother substrate bonding process, the sealing material is already cured when the light-shielding material is applied, which eliminates a problem of insufficient curing of the sealing material due to the frame light-shielding layer 25 blocking light from entering the seal region SL. Thus, it is possible to form the frame light-shielding layer 25 such that the entire frame region F is used as the frame light-shielding region SD.

Cutting Process

After the light-shielding film is formed on the surface of the first mother substrate, the mother substrate assembly is cut into individual panels in a size where one color filter substrate 20 and one array substrate 30 face each other.

First and Second Polarizing Plates Bonding Process

At last, in each panel, a first polarizing plate 61 is bonded to a surface of the color filter substrate 20, and a second polarizing plate 62 is bonded to a surface of the array substrate 30, respectively. By bonding the first polarizing plate 61 to the surface of the color filter substrate 20, the inter-pixel light-shielding layer 24 and the frame light-shielding layer 25 are sandwiched by the color filter substrate 20 and the first polarizing plate 61. Thereafter, by mounting a driver module and the like onto the panel that has the first and second polarizing plates 61 and 62 bonded thereto, the liquid crystal display device 10 can be obtained.

(Second Manufacturing Method of Liquid Crystal Display Device)

The second manufacturing method of the liquid crystal display device 10 includes a mother substrate fabricating process, a liquid crystal layer forming process, a mother substrate bonding process, a first light-shielding material application process, a cutting process, a second light-shielding material application process, and a first and second polarizing plates bonding process.

Mother Substrate Fabricating Process to Mother Substrate Bonding Process

At first, in a manner similar to the first manufacturing method above, the mother substrate fabricating process, the liquid crystal layer forming process, and the mother substrate bonding process are performed, thereby obtaining a mother substrate assembly.

First Light-Shielding Material Application Process

Next, a light-shielding material is applied by an ink-jet method to a surface of the first mother substrate in regions where the frame regions are to be formed (regions where frame light-shielding layers 25 are to be formed) and where inter-pixel light-shielding layers 24 are to be formed, thereby forming a light-shielding film. This light-shielding film is used to form the inter-pixel light-shielding layers 24 and the frame light-shielding layers 25. Because curing of the sealing material was performed in the mother substrate bonding process, the sealing material is already cured when the light-shielding material is applied, which eliminates a problem of insufficient curing of the sealing material due to the frame light-shielding layer 25 blocking light from entering the seal region SL. Thus, it is possible to form the light-shielding film such that the entire frame region F is used as the frame light-shielding region SD.

Cutting Process

After the surface of the first mother substrate is coated with a light-shielding film, the mother substrate assembly is cut into individual panels in a size where one color filter substrate 20 and one array substrate 30 face each other.

Second Light-Shielding Material Application Process

Next, a light-shielding material is applied by an ink-jet method to each panel obtained through the cutting process so as to coat the area where the light-shielding film is formed, thereby forming the inter-pixel light-shielding layer 24 and the frame light-shielding layer 25, respectively. This way, even if an end of the light-shielding film formed in the first light-shielding material application process is damaged in the cutting process, because the light-shielding film is coated with another layer of the light-shielding material, it is possible to achieve excellent light-shielding performance in the inter-pixel light-shielding layer 24 and in the frame light-shielding layer 25, respectively.

First and Second Polarizing Plates Bonding Process

At last, in each panel, a first polarizing plate 61 is bonded to a surface of the color filter substrate 20, and a second polarizing plate 62 is bonded to a surface of the array substrate 30, respectively. By bonding the first polarizing plate 61 to the surface of the color filter substrate 20, the inter-pixel light-shielding layer 24 and the frame light-shielding layer 25 are sandwiched by the color filter substrate 20 and the first polarizing plate 61. Thereafter, by mounting a driver module and the like onto the panel that has the first and second polarizing plates 61 and 62 bonded thereto, the liquid crystal display device 10 can be obtained.

In the first manufacturing method and the second manufacturing method, manufacturing methods in which the inter-pixel light-shielding layer 24 and the frame light-shielding layer 25 are formed of a black resin were explained. However, when the respective light-shielding layers are to be formed of a metal, these layers can be formed by photolithography, for example.

Also, in the first manufacturing method and the second manufacturing method, the liquid crystal layer forming process by the one drop fill method was performed before the mother substrate bonding process, but the present invention is not limited to such. For example, the liquid crystal layer 50 may be formed by a liquid crystal injection method after the mother substrate bonding process, or the liquid crystal layer 50 may be formed by a liquid crystal injection method after the light-shielding material application process. Further, the liquid crystal layer 50 may be formed by a liquid crystal injection method after obtaining a panel by cutting the mother substrate assembly in the cutting process.

In the first manufacturing method and the second manufacturing method, the panels were obtained by cutting the mother substrate assembly after bonding the first mother substrate and the second mother substrate, but the present invention is not limited to such. For example, it is also possible to constitute a panel by bonding a single color filter substrate 20 and a single array substrate 30 to each other.

Also, in the first manufacturing method and the second manufacturing method, the first polarizing plate and the second polarizing plate were bonded at the same time, but the present invention is not limited to such. The second polarizing plate may be bonded to a panel any time after the mother substrate assembly is divided into panels in the cutting process.

<Effects of Embodiment 1>

With the configuration of this embodiment, the frame light-shielding layer 25 is disposed in the frame region F between the color filter substrate 20 and the first polarizing plate 61, thereby forming the frame light-shielding region SD. Therefore, even if the seal region SL and the frame light-shielding region SD overlap each other in a plan view, it is possible to dispose the sealing member 40 such that the sealing member 40 is directly adhered to the color filter substrate 20. This makes it possible to achieve a layout of the frame region F in which the seal region SL and the frame light-shielding region SD overlap, without decreasing the seal strength. As a result, a narrower frame in the display panel can be achieved.

In the liquid crystal display device 10 of this embodiment, the frame light-shielding layer 25 is disposed between the color filter substrate 20 and the first polarizing plate 61. If the frame light-shielding layer is disposed on a surface of the color filter substrate on the side facing the liquid crystal layer as in a conventional liquid crystal display device, two substrates would be bonded to each other by the sealing member after the frame light-shielding layer was formed. Therefore, if the region where the sealing member is disposed is blocked by the frame light-shielding layer, it would be difficult to cure the sealing member by light radiation. This would create a need to form the frame light-shielding layer so as not to overlap the seal region. However, in the liquid crystal display device 10 of this embodiment, the frame light-shielding layer 25 is to be disposed between the color filter substrate 20 and the first polarizing plate 61, the frame light-shielding layer 25 is formed after the color filter substrate 20 and the array substrate 30 are bonded to each other, that is, after the sealing member 40 is cured. This makes it possible to form the frame light-shielding region SD without taking into account a step of curing the sealing member 40. As a result, it is possible to arrange the frame light-shielding region SD and the seal region SL so as to overlap each other in a plan view, which makes possible a narrower frame. Also, it is possible to use the entire frame region F as the frame light-shielding region SD. This allows for an excellent light-shielding performance in the frame region F, and the liquid crystal display device 10 can perform a display with higher brightness.

Although the frame light-shielding layer 25 is disposed on the surface of the color filter substrate 20 of the panel, because the frame light-shielding layer 25 is formed between the color filter substrate 20 and the first polarizing plate 61, it eliminates a possibility that the first polarizing plate 61 is damaged due to external influences.

<Modification Examples of Embodiment 1>

In Embodiment 1, the frame light-shielding region SD was disposed so as to cover the entire frame region F, but the present invention is not limited to such. The frame light-shielding region SD may be disposed so as to cover a part of the frame region F. In this case, in order to improve display brightness by preventing light leakage from a display region, it is preferable that the frame light-shielding region SD be provided in the frame region F so as to include a border between the frame region F and the display region D as shown in FIG. 6 as Modification Example 1. In Embodiment 1, the entire seal region SL was disposed within the frame light-shielding region SD in a plan view, but if the frame light-shielding region SD is not formed so as to cover the entire frame region F, the seal region SL may be disposed so as to overlap a part of the frame light-shielding region SD as shown in FIG. 6.

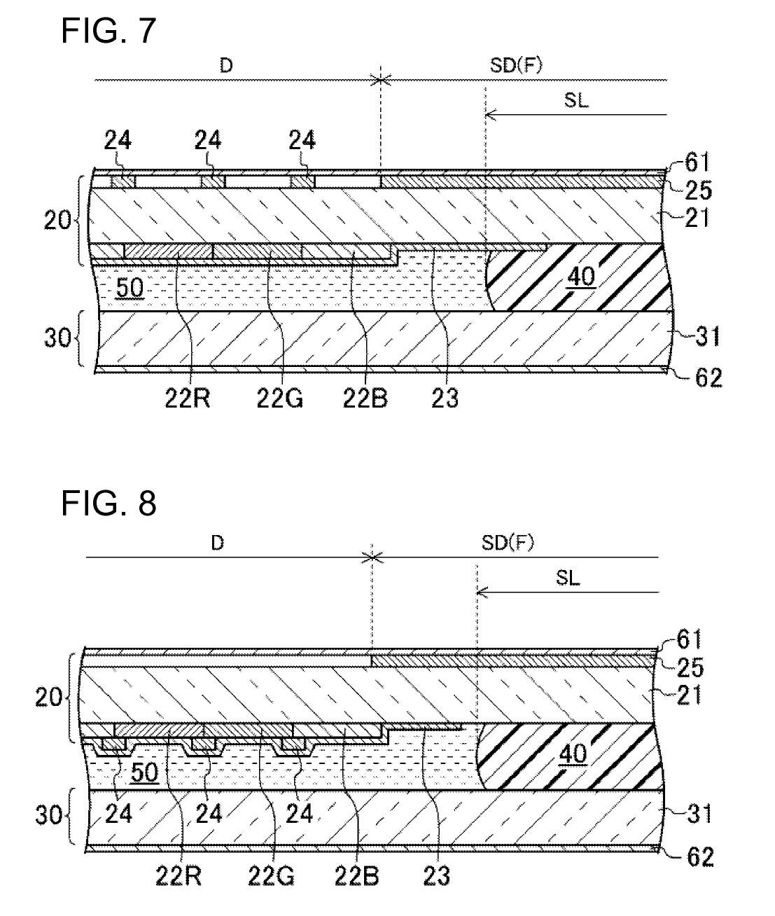

In Embodiment 1, the common electrode 23 of the color filter substrate 20 was disposed such that the common electrode 23 does not overlap the seal region SL in a region where the transfer pads 32 are not formed, but alternatively, the common electrode 23 may be disposed such that a part thereof overlaps a part of the seal region SL as shown in FIG. 7 as Modification Example 2, for example. Even with this configuration, in the seal region SL, the sealing member 40 is directly adhered to the substrate 21 in regions where the sealing member 40 does not overlap the common electrode 23, and therefore, a sufficient seal strength can be ensured by those regions.

In Embodiment 1, the inter-pixel light-shielding layer 24 and the frame light-shielding layer 25 were made of the same material in the same layer, but the present invention is not limited to such as long as the frame light-shielding layer 25 is disposed between the color filter substrate 20 and the first polarizing plate 61. For example, as shown in FIG. 8 as Modification Example 3, the inter-pixel light-shielding layer 24 may be formed on the surface of the substrate 21 on the side facing the liquid crystal layer 50. However, it is preferable that the inter-pixel light-shielding layer 24 and the frame light-shielding layer 25 be disposed in the same layer because it allows the inter-pixel light-shielding layer 24 and the frame light-shielding layer 25 to be formed at the same time, and the manufacturing process can be simplified.

### Embodiment 2

<Configuration of Liquid Crystal Display Device>

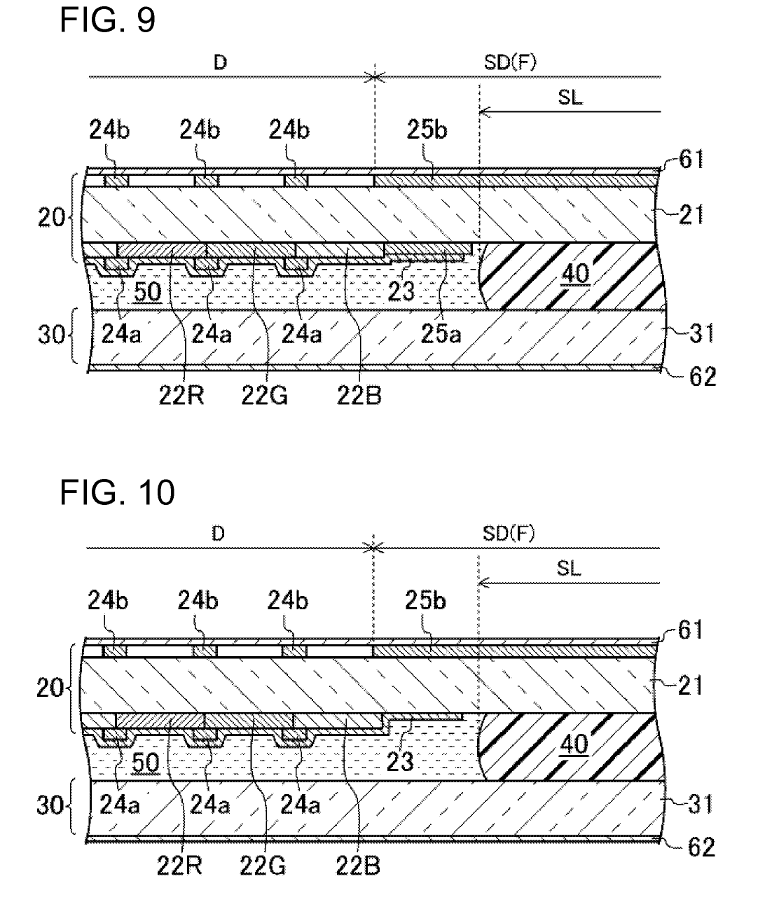

FIG. 9 shows a liquid crystal display device 10 of Embodiment 2. FIG. 9 is a cross-sectional view that corresponds to a cross-sectional view along the line IV-IV in FIG. 3 that is a plan view of the liquid crystal display device 10 of Embodiment 1. In a manner similar to Embodiment 1, the liquid crystal display device 10 has a color filter substrate 20 (first substrate) and an array substrate 30 (second substrate) facing each other, and the two substrates 20 and 30 are bonded to each other by a sealing member 40 that is disposed in a frame shape in a seal region SL on the outer circumference thereof. In a space surrounded by the sealing member 40 between the two substrates 20 and 30, a liquid crystal layer 50 is provided as a display layer.

The liquid crystal display device 10 has a display region D inside the sealing member 40, where a plurality of pixels are arranged in a matrix, and a region that surrounds the display region is a frame region F.

(Color Filter Substrate)

In the color filter substrate 20, respective colored layers of red colored layers 22R, green colored layers 22G, and blue colored layers 22B are formed on the surface of the substrate 21 on the side facing the liquid crystal layer 50 so as to correspond to respective pixels in the display region D. An inter-pixel light-shielding layer 24a is formed on the respective color layers 22R, 22G, and 22B so as to border the respective pixels. On the respective colored layers 22R, 22G, and 22B, a common electrode 23 is formed of ITO or the like in a thickness of about 100 nm, for example, and an alignment film (not shown) is formed so as to cover the common electrode 23. The color filter substrate 20 also has a frame light-shielding layer 25a on the surface of the substrate 21 on the side facing the liquid crystal layer 50 in a region within the frame region F between the seal region SL and the display region D. The respective inter-pixel light-shielding layer 24a and frame light-shielding layer 25a are formed of a black resin, metal chrome, or the like, for example. The inter-pixel light-shielding layer 24a and the frame light-shielding layer 25a are formed of the same material in the same layer.

In the display region D, the common electrode 23 is formed so as to cover the entire display region D. On the other hand, in the frame region F, the common electrode 23 is formed so as to correspond to regions where transfer pads 32 are formed.

The color filter substrate 20 also includes, on the surface of the substrate 21 on the side opposite to the liquid crystal layer 50, an inter-pixel light-shielding layer 24b formed so as to border the respective pixels in the display region D, and a frame light-shielding layer 25b formed so as to cover the entire frame region F. The frame light-shielding region SD is defined by the frame light-shielding layer 25. That is, the frame light-shielding region SD is formed so as to cover the entire frame region F. The respective inter-pixel light-shielding layer 24b and frame light-shielding layer 25b are formed of a black resin, metal chrome, or the like, for example. The inter-pixel light-shielding layer 24b and the frame light-shielding layer 25b are formed of the same material in the same layer.

(Array Substrate)

In a manner similar to Embodiment 1, the array substrate 30 has a configuration that is conventionally known.

(Sealing Member)

In a manner similar to Embodiment 1, on the outer circumference of the color filter substrate 20 and the array substrate 30, the seal region SL is defined in a ring shape in the frame region F, and the sealing member 40 is disposed so as to extend along the seal region SL. The sealing member 40 bonds the color filter substrate 20 and the array substrate 30 to each other.

(Liquid Crystal Layer)

The liquid crystal layer 50 is made of a nematic liquid crystal material or the like that has electrooptic characteristics.

(Polarizing Plate)

The first and second polarizing plates 61 and 62 are respectively provided on a surface of the color filter substrate 20 and a surface of the array substrate 30. Each of the first and second polarizing plates 61 and 62 has a known configuration.

In the liquid crystal display device 10 having the above configuration, one pixel is defined for each pixel electrode, and in each pixel, when the TFT is turned on as a result of a gate signal sent through the gate line, a source signal is received through the source line, causing prescribed electrical charges to be written into the pixel electrode through the source electrode and the drain electrode. This creates a difference in potential between the pixel electrode and the common electrode 23 of the color filter substrate 20, and as a result, a prescribed voltage is applied to a liquid crystal capacitance made of the liquid crystal layer 50. The orientation state of the liquid crystal molecules changes depending on the size of the voltage applied thereto, and by utilizing the change in the orientation state to adjust the transmittance of light that enters from the outside, the liquid crystal display device 10 displays an image.

<Manufacturing Method of Liquid Crystal Display Device>

The manufacturing method of the liquid crystal display device 10 includes a mother substrate fabricating process, a liquid crystal layer forming process, a mother substrate bonding process, a light-shielding material application process, a cutting process, and a first and second polarizing plates bonding process.

Mother Substrate Fabricating Process

First, a first mother substrate for forming a plurality of color filter substrates 20 is fabricated. For example, at first, colored layers 22R, 22G, and 22B are formed on the first mother substrate by a known method, and thereafter, by an ink-jet method or the like, for example, the inter-pixel light-shielding layer 24a is formed so as to border the respective pixels, and the frame light-shielding layer 25a is formed in the frame region F. Next, the common electrode 23 is formed so as to cover the colored layers 22R, 22G, and 22B, the inter-pixel light-shielding layer 24a, the frame light-shielding layer 25b, and the like. Thereafter, an alignment film is formed. Separately from the first mother substrate, a second mother substrate for forming a plurality of array substrates 30 is fabricated by a known method.

Liquid Crystal Layer Forming Process to Polarizing Plate Bonding Process

After the mother substrate fabricating process, a liquid crystal layer forming process, a mother substrate bonding process, a light-shielding material application process, a cutting process, and a first and second polarizing plates bonding process are performed. These processes are formed in the same manner as the first manufacturing method in Embodiment 1, and therefore, the descriptions are omitted.

<Effects of Embodiment 2>

In the liquid crystal display device 10 of this embodiment, the inter-pixel light-shielding layers 24a and 24b and the frame light-shielding layers 25a and 25b are formed on both surfaces of the color filter substrate 20 on the side facing the liquid crystal layer 50 and on the side opposite thereto. This makes it possible to achieve an excellent light-shielding performance, in addition to the effects obtained in Embodiment 1. Thus, an excellent display performance with high brightness can be achieved.

<Modification Examples of Embodiment 2>

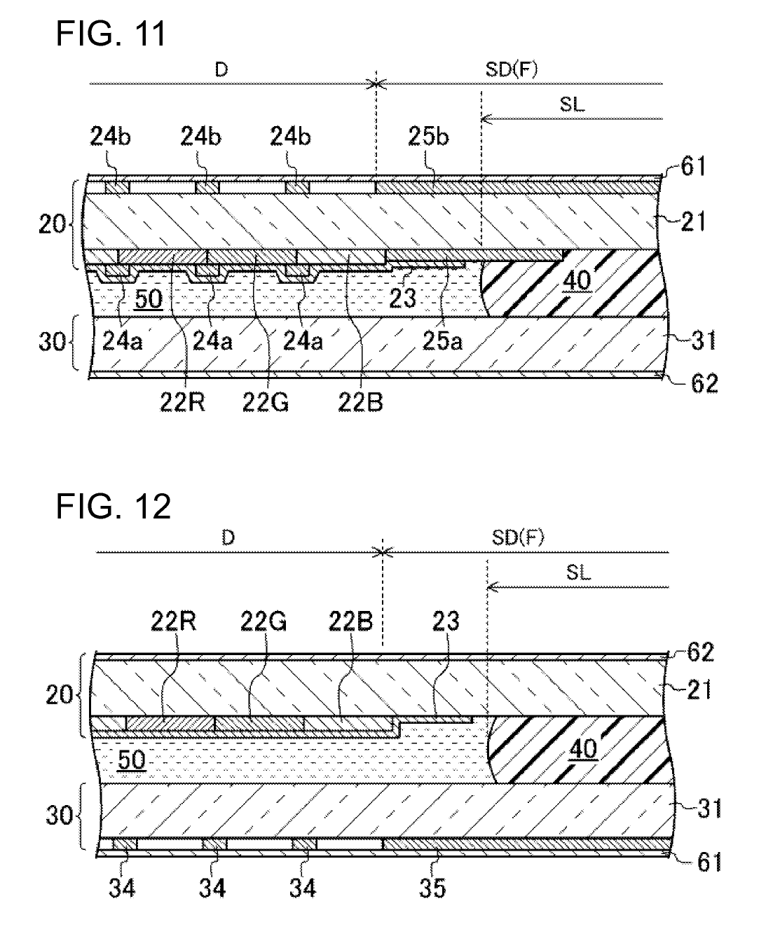

In Embodiment 2, the color filter substrate 20 was provided with the frame light-shielding layer 25a that is formed on the surface of the substrate 21 on the side facing the liquid crystal layer 50 in a region within the frame region F between the seal region SL and the display region D. However, the present invention is not limited to such. For example, as shown in FIG. 10 as Modification Example 4, it is possible that a frame light-shielding layer is not formed on the surface of the substrate 21 on the side facing the liquid crystal layer 50, and that the frame light-shielding region SD is formed in the frame region F by the frame light-shielding layer 25b formed between the substrate 21 and the first polarizing plate 61. Also, as shown in FIG. 11 as Modification Example 5, the frame light-shielding layer 25a may be formed such that a part thereof overlaps a part of the seal region SL. In this case, although the seal strength is reduced in the region where the frame light-shielding layer 25a and the seal region SL overlap due to the sealing member 40 not being directly adhered to the substrate 21, because the sealing member 40 is directly adhered to the substrate 21 in a region of the seal region SL where the sealing member 40 does not overlap the frame light-shielding layer 25a, a sufficient seal strength can be ensured.

### Other Embodiments

In Embodiments 1 and 2, the first polarizing plate 61 was disposed on the color filter substrate 20 on the side opposite to the liquid crystal layer 50, but the present invention is not limited to such. For example, it is possible that the array substrate 30 and the color filter substrate 20 respectively serve as the first substrate and the second substrate, and that the first polarizing plate 61 is formed on a surface of the array substrate 30 and the second polarizing plate 62 is formed on a surface of the color filter substrate 20. In this case, as shown in FIG. 12 as Modification Example 6, an inter-pixel light-shielding layer 34 and a frame light-shielding layer 35 are disposed between the array substrate 30 and the first polarizing plate 61.

With the liquid crystal display device 10 having the configuration of Modification Example 6, it is possible to form the inter-pixel light-shielding layer 34 in a proper position relative to TFTs that are formed on the array substrate 30, and as a result, it is possible to prevent openings from being smaller due to alignment errors between the inter-pixel light-shielding layer and TFTs. However, taking into account a possibility that light that passed through the respective colored layers 22R, 22G, and 22B is refracted and leaks to adjacent pixels, thereby causing a degradation of color purity, it is preferable that the first polarizing plate 61 be formed on a surface of the color filter substrate 20 and that the inter-pixel light-shielding layer 24 and the frame light-shielding layer 25 be disposed between the color filter substrate 20 and the first polarizing plate 61.

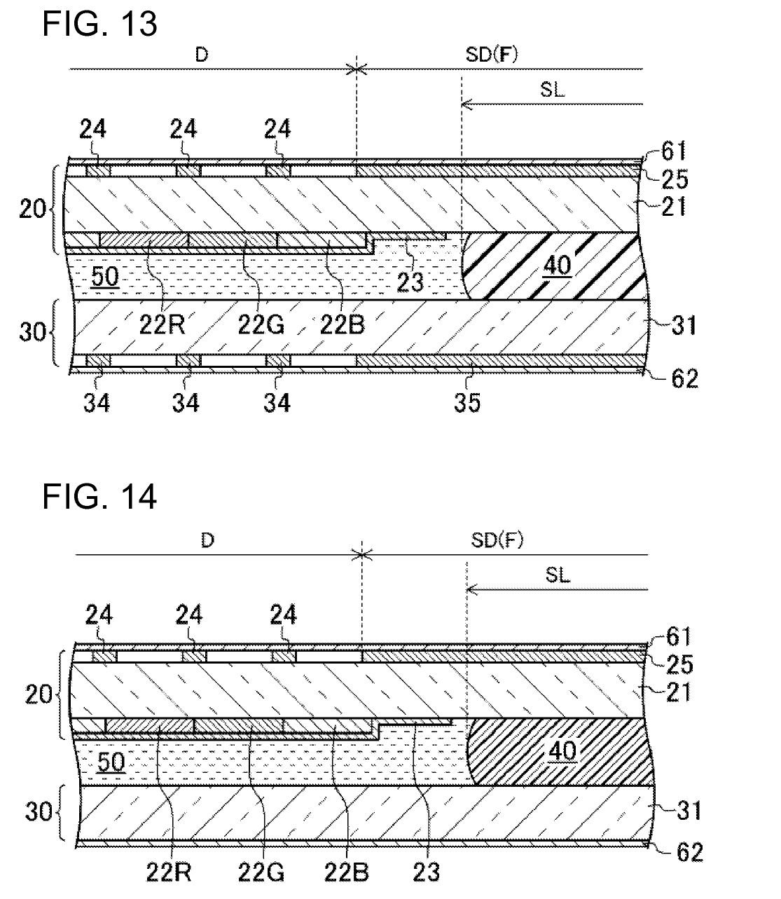

In Embodiments 1 and 2, the inter-pixel light-shielding layer 24 (24a, 24b) and the frame light-shielding layer 25 (25a, 25b) were formed on the surface of the color filter substrate 20. However, as shown in FIG. 13 as Modification Example 7, the inter-pixel light-shielding layer 34 and the frame light-shielding layer 35 may further be provided between the array substrate 30 and the second polarizing plate 62.

In Embodiments 1 and 2, the color filter substrate 20 and the array substrate 30 were bonded to each other by the sealing member 40 that is made of a transparent acrylic resin, epoxy resin, or the like. However, as shown in FIG. 14 as Modification Example 8, for example, the color filter substrate 20 and the array substrate 30 may be bonded to each other by a black sealing member 41. The black sealing member 41 may be formed of a material that is obtained by adding a black colorant such as carbon black to an acrylic resin, an epoxy resin, or the like, for example. When the two substrates 20 and 30 are bonded by the black sealing member 41, which allows little light to pass through, light-shielding performance can be improved as compared with a case where the sealing member 40, which is transparent, is used.

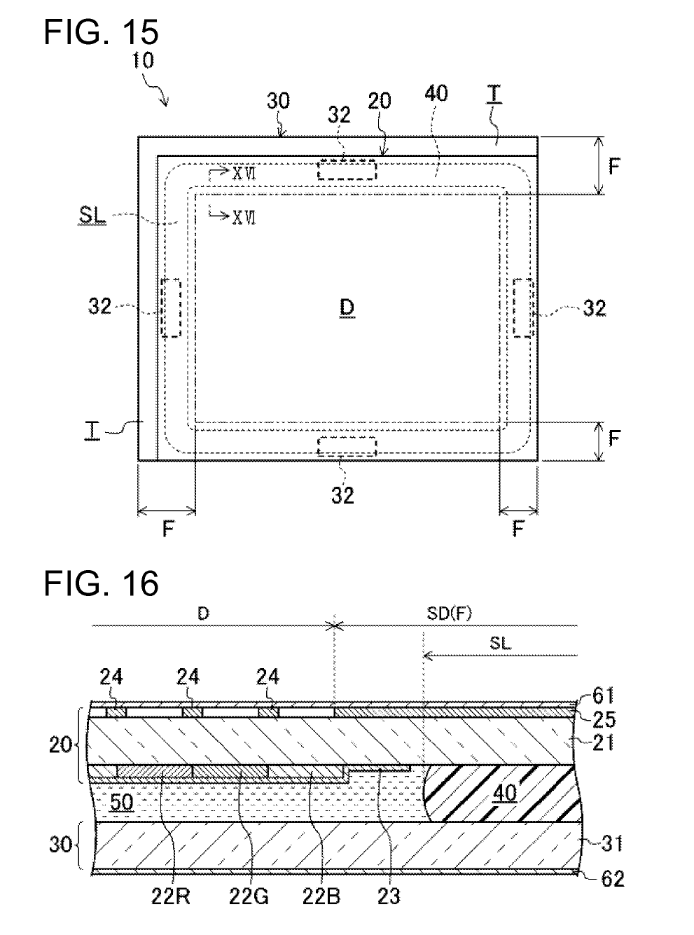

In Embodiments 1 and 2, the transfer pads 32 were arranged in a manner shown in the plan view of FIG. 3, but the present invention is not limited to such. For example, as shown in FIG. 15 as Modification Example 9, instead of providing transfer pads at the corners of the array substrate 30, the transfer pads 32 may be provided in the middle portion of each side.

When the transfer pads 32 are arranged as in Modification Example 9, the sealing member 40 can be directly adhered to the substrate 21 at the corners of the substrates of the liquid crystal display device 10 as shown in FIG. 16, thereby achieving an excellent seal strength.

In the liquid crystal display device 10, corners of the substrates generally require a greater strength as compared with other portions, and therefore, with the configuration of Modification Example 9, a sufficient seal strength can be ensured more efficiently in the liquid crystal display device 10 as a whole.

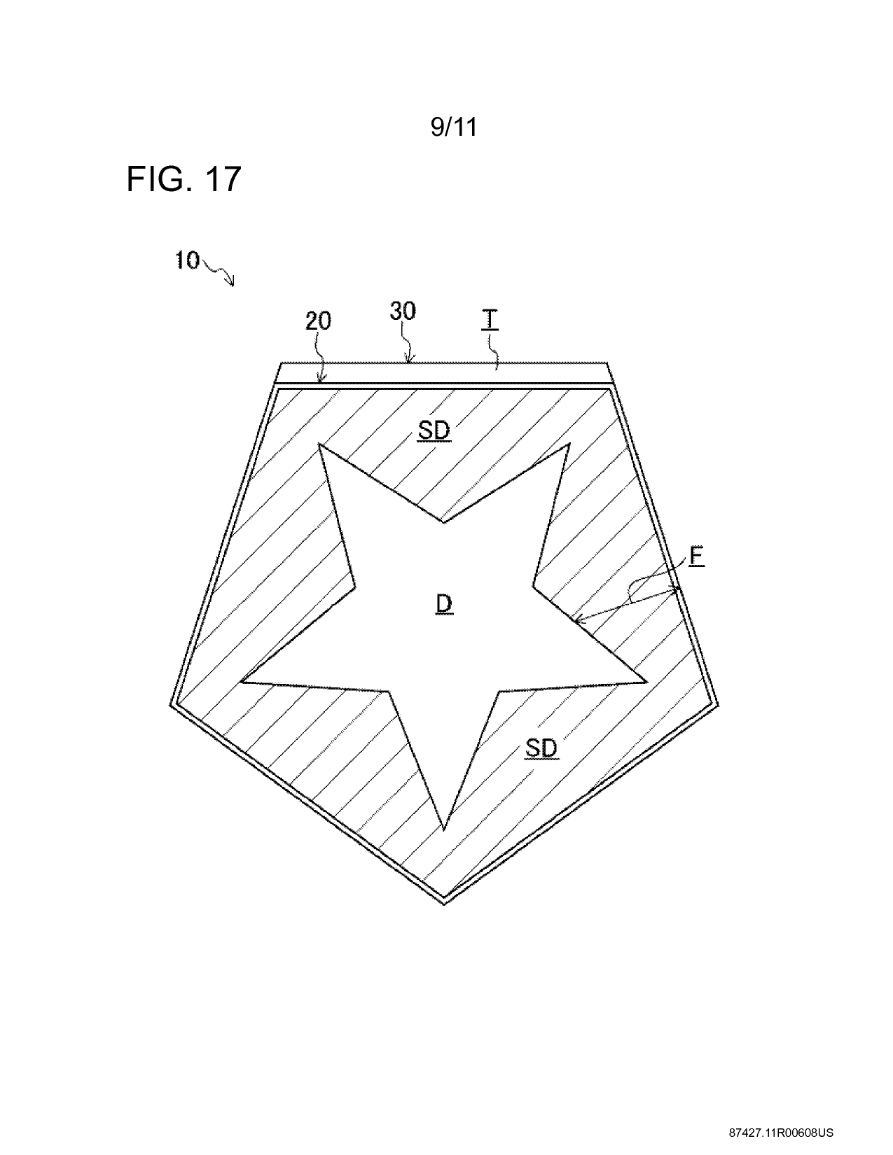

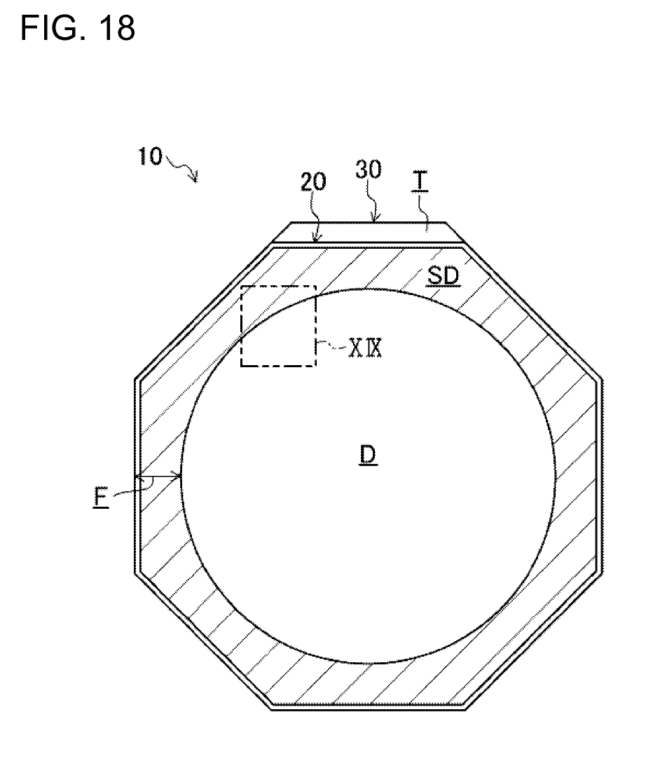

In Embodiments 1 and 2, the display region D of the liquid crystal display device 10 was in a rectangular shape, but the present invention is not limited to this. For example, the display region D may have a polygonal shape or a circular shape instead of a rectangular shape. If the display region D is formed in a polygonal shape, the shape of the display region D may be a decagram as shown in FIG. 17 as Modification Example 10, for example, or may be a triangle, a pentagon, or the like. If the display region D is formed in a circular shape, the shape of the display region may be a perfect circle as shown in FIG. 18 as Modification Example 11, for example, or may be an oval or an ellipse. In addition to rectangular, polygonal, and circular shapes, any appropriate shape may be used as the shape of the display region D.

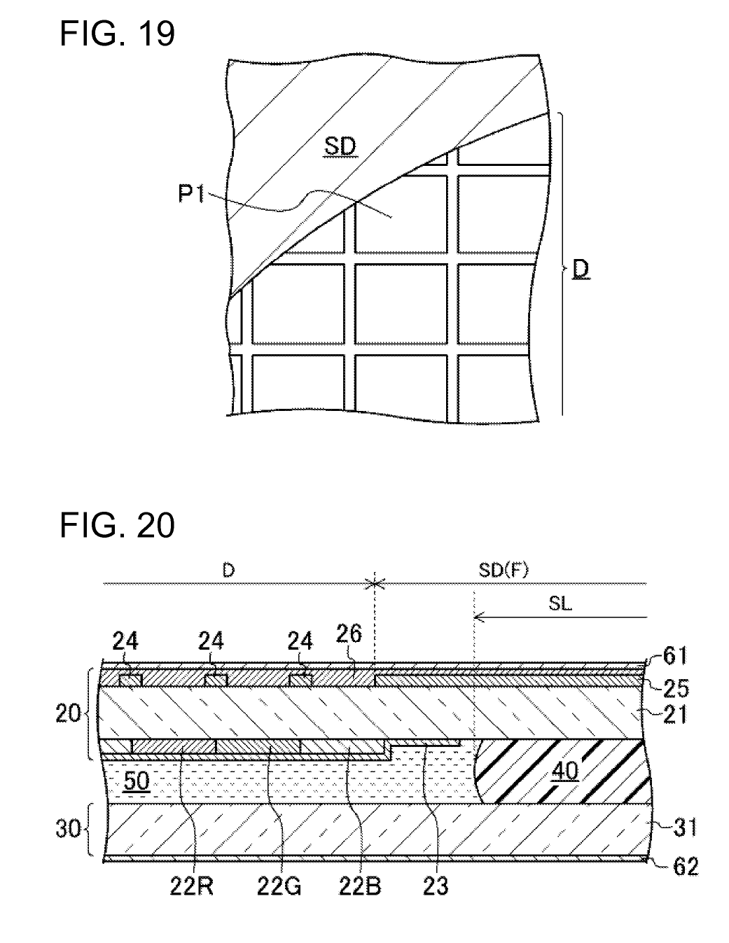

When the display region D is in a shape other than a rectangular shape, it is possible that there are some pixels that are partially covered by the frame light-shielding region SD near the border between the display region D and the frame region F. For example, when the display region D is in a circular shape, some pixels are partially covered by the frame light-shielding region SD as shown with a pixel P1 in FIG. 19. When such a pixel P1 is present, if the frame light-shielding layer is formed on the color filter substrate on the side facing the liquid crystal layer, a step between the frame light-shielding layer and the color filter is created, possibly causing disarrayed liquid crystal orientation in the pixel P1. However, because the frame light-shielding layer 25 is formed on the color filter substrate 20 on the side opposite to the liquid crystal layer 50, the above-mentioned problem can be prevented.

In Embodiments 1 and 2, the inter-pixel light-shielding layer 24 (24a, 24b) and the frame light-shielding layer 25 (25a, 25b) were disposed between the color filter substrate 20 and the first polarizing plate 61, but as shown in FIG. 20 as Modification Example 12, a planarizing film 26 may further be provided so as to cover the outer surface of the color filter substrate 20. The polarizing film 26 is formed so as to fill spaces between the inter-pixel light-shielding layer 24 and the frame light-shielding layer 25 on the color filter substrate 20 and so as to planarize the surface of the color filter substrate 20. With the configuration of Modification Example 12, the surface of the color filter substrate 20 can be planarized by the planarizing film 26, and it is possible to eliminate a gap between the color filter substrate 20 and the first polarizing plate 61 in regions where the inter-pixel light-shielding layer 24 or the frame light-shielding layer 25 is not formed. This prevents light that passes through the color filter substrate 20 and the first polarizing plate 61 from being refracted at the gap therebetween, thereby achieving superior display visibility. The planarizing film 26 may be formed of an adhesive film such as an acrylic gel sheet that is used to bond the first polarizing plate 61 to the color filter substrate 20, or may be formed of a transparent resin layer made of a transparent resin coating such as an acrylic resin with a planarized surface. It is preferable that the planarizing film 26 be made of a material that has the same refractive index as that of the first polarizing plate 61.

### INDUSTRIAL APPLICABILITY

The present invention is useful as a liquid crystal display device that can achieve a narrower frame without decreasing the seal strength and as a manufacturing method thereof.

### DESCRIPTION OF REFERENCE CHARACTERS

D display region

F frame region

SD frame light-shielding region

SL seal region

10 liquid crystal display device

20 color filter substrate (first substrate)

24, 24a, 24b, 34 inter-pixel light-shielding layer

25, 25a, 25b, 35 frame light-shielding layer

30 array substrate (second substrate)

40 sealing member

41 black sealing member

50 liquid crystal layer

61 first polarizing plate

62 second polarizing plate

1. A liquid crystal display device, comprising:
a first substrate and a second substrate disposed to face each other;
a sealing member provided in a seal region that is a region continuously formed in a ring shape along a frame region that surrounds a display region, the sealing member bonding the first substrate and the second substrate to each other;
a liquid crystal layer provided in a region enclosed by the sealing member between the first substrate and the second substrate;
a first polarizing plate disposed on the first substrate on a side opposite to the liquid crystal layer;
a second polarizing plate disposed on the second substrate on a side opposite to the liquid crystal layer; and
a frame light-shielding layer disposed, at least between the first substrate and the first polarizing plate, in a region within the frame region that overlaps at least a part of the seal region, the frame light-shielding layer defining a frame light-shielding region.

2. The liquid crystal display device according to claim 1, wherein the first substrate is a color filter substrate that has colored layers provided for respective pixels, and
wherein the second substrate is an array substrate that has switching elements formed so as to correspond to the respective pixels.

3. The liquid crystal display device according to claim 2, wherein, between the color filter substrate and the first polarizing plate, an inter-pixel light-shielding layer is formed of a same layer as the frame light-shielding layer so as to correspond to a region that borders the respective colored layers.

4. The liquid crystal display device according to claim 1, wherein the sealing member is black.

5. The liquid crystal display device according to claim 1, wherein the display region is in a polygonal shape.

6. The liquid crystal display device according to claim 1, wherein the display region is in a circular shape.

7. A method of manufacturing the liquid crystal display device according to claim 2, comprising:
a mother substrate bonding step of bonding a first mother substrate from which a plurality of said color filter substrates are formed and a second mother substrate from which a plurality of said array substrates are formed, thereby forming a mother substrate assembly;
a first light-shielding material application step of forming, by an ink-jet method, a light-shielding film on a surface of the mother substrate assembly, which was obtained in the mother substrate bonding step, on a side of the first mother substrate in a region that corresponds to a frame region;
a cutting step of cutting the mother substrate assembly into individual panels, each of which has one color filter substrate and one array substrate facing each other, after forming the light-shielding film in the first light-shielding material application step;
a second light-shielding material application step of applying a light-shielding material by an ink-jet method on a surface of a panel, which was obtained in the cutting step, in a region that corresponds to a location where the light-shielding film is formed, thereby forming a frame light-shielding layer;
a liquid crystal layer forming step of filling a space between the color filter substrate and the array substrate with a liquid crystal material, the liquid crystal layer forming step being performed before the mother substrate bonding step, or after one of the mother substrate bonding step, the first light-shielding material application step, a cutting step, and the second light-shielding material application step;
a first polarizing plate bonding step of bonding a first polarizing plate to a surface of the panel on a side of the color filter substrate after the second light-shielding material application step; and
a second polarizing plate bonding step of bonding a second polarizing plate to a surface of the panel on a side of the array substrate, subsequent to one of the cutting step, the second light-shielding material application step, and the first polarizing plate bonding step.
